(19) United States
(12) Patent Application Publication
(10) Pub. No.: US 2024/0057663 A1
(43) Pub. Date: Feb. 22, 2024

(54) Wood Clad Magnetic Attachment Systems and Methods of Manufacture

(71) Applicant: Benchmark Cigar LLC, Gunter, TX (US)

(72) Inventor: Daniel P. Jackson, Prosper, TX (US)

(21) Appl. No.: 18/451,270

(22) Filed: Aug. 17, 2023

Related U.S. Application Data
(60) Provisional application No. 63/398,733, filed on Aug. 17, 2022.

(51) Int. Cl. A24F 25/02; A24F 15/12; B65D 1/34; B65D 6/02; B65D 21/02; B65D 25/04; B65D 43/00; B65D 51/28; B65D 81/18; B65D 85/12

(52) U.S. Cl. CPC A24F 25/02; A24F 15/12; B65D 1/34; B65D 9/06; B65D 21/0209; B65D 25/04; B65D 43/00; B65D 51/28; B65D 81/18; B65D 85/12; B65D 2205/02; B65D 2313/04; H01F 7/02

(57) ABSTRACT

Devices, systems, and methods using embedded magnets are provided. In some embodiments, a system of using embedded magnets in a humidor is provided. In some embodiments, devices, systems and methods for attaching a humidor accessory to a humidor are provided.

### CROSS-REFERENCE TO RELATED APPLICATION

This application is related to and claims priority benefits from U.S. provisional patent application Ser. No. 63/398,733 filed on Aug. 17, 2022, entitled “Wood Clad Magnetic Attachment Systems and Methods of Manufacture”. The '733 application is hereby incorporated by reference herein in its entirety.

### FIELD OF THE INVENTION

This disclosure generally relates to magnets embedded in wood. In some particular instances, this disclosure relates to embedded magnets in humidors and humidor accessories.

Proper cigar storage is important to preserve the quality of a cigar. Improper storage in an environment that is too humid or not humid enough can lead to cracking, a loss of flavor, a bitter flavor, and/or mold.

Humidors are typically used to store cigars at a controlled temperature and humidity. Generally, humidor interiors are crafted using moisture retaining wood, which contributes to a humidity regulated environment for the cigars. Additionally, many humidors contain moisture control accessories that further assist in regulating the environment inside a humidor. For instance, a moisture control accessory can be inserted into a humidor. Despite aiding in regulating the environment in a humidor, some moisture control accessories take up space that is intended or can be needed to store cigars. Additionally, if an accessory is not secured, it can move or fall on the cigars, potentially damaging them.

In some instances, a moisture control accessory can be attached to the humidor. Oftentimes, such an accessory is attached to the inside of a lid of a humidor. Moisture control packet holders are typically attached using an adhesive such as glue or double-sided tape. They can also be attached using hook-and-loop strips adhered to the lid and accessory.

Traditional adhesives such as glue or double-sided tape can lose their adhesive strength in a humid environment such as in a humidor. A decrease in adhesive strength can cause any attached accessory to fall on any stored cigars, potentially damaging them.

Furthermore, cigar smokers not only buy humidors for their function, but they also buy them for their design. Many humidors are made with polished or stained wood with metal fittings to give off a high-class feel and look. In certain instances, humidors can employ magnets. Many times the magnets are exposed or not recessed. In these cases, the exposed metal casing of the magnets and potentially sharp edges can scratch the interior surfaces to which they are applied, thus degrading their appearances.

Therefore, there is a need for improved systems and methods of securing humidor accessories while allowing for a discreet humidor design.

### SUMMARY OF THE INVENTION

There are several aspects of the present subject matter which can be embodied separately or together in the subject matter claimed below. These aspects can be employed alone or in combination with other aspects of the subject matter described herein, and the description of these aspects together is not intended to preclude the use of these aspects separately or the claiming of such aspects separately or in different combination as set forth in the claims appended hereto.

A portable humidor can include a body made at least in part of a wood with at least one embedded magnet; and a lid made at least in part of a wood.

In some embodiments, the lid includes at least one embedded magnet. In some embodiments, the lid includes at least one embedded ferromagnetic material. In some embodiments, the body includes a front panel, a back panel; and a core. In some embodiments, at least one edge of the front panel is concave in shape. In some embodiments, a first side wall of the core is concave in shape.

In some embodiments, at least one inner surface of the portable humidor is made of Spanish cedar.

In some embodiments, the portable humidor o has a chamber defined by a front panel, a back panel, and a core, wherein the chamber is configured to hold three 60 ring gauge cigars.

In some embodiments, the lid has a beveled side surface. In some embodiments, the core has at least one cavity configured to receive at least one embedded magnet. In some embodiments, the lid has at least one cavity configured to receive at least one embedded magnet.

In some embodiments, the at least one embedded ferromagnetic material is a metal plate.

In some embodiments, a wooden packet holder made at least partially of a wood can include a first panel, a second panel; and at least one spacer. In some embodiments, the first panel comprises a plurality of vents. In some embodiments, the wooden packet holder is made at least in part of Spanish cedar. In some embodiments, the wooden packet holder is made entirely out of Spanish cedar with the exception of any magnets. In some embodiments, the at least one spacer comprises at least one recess configured to hold a magnet.

In some embodiments, a humidor system includes a humidor; and a wooden packet holder with at least one embedded magnet, wherein the humidor has a body made at least in part of a wood and a lid made at least in part of a wood. In some embodiments, the lid includes at least one of a second embedded magnet or a ferromagnetic material such that the wooden packet holder can be attached to the lid via a magnetic force.

In some embodiments, a wood clad magnet includes a wooden container and a magnet. In some embodiments, the shape of the wooden container is one of a cube, a rectangular prism, a pyramid, a sphere, or a cylinder.

### BRIEF DESCRIPTION OF THE DRAWINGS

FIG. 1A is a perspective view of an embodiment of a wood clad magnet.

FIG. 1B is a perspective view of another embodiment of a wood clad magnet.

FIG. 1C is a perspective view of another embodiment of a wood clad magnet.

FIG. 2A is an exploded perspective view of the embodiment of the wood clad magnet of FIG. 1A.

FIG. 2B is an exploded perspective view of the embodiment of the wood clad magnet of FIG. 1B.

FIG. 2C is an exploded perspective view of the embodiment of the wood clad magnet of FIG. 1C.

FIG. 3 is a perspective view of an embodiment of a humidor with embedded magnets.

FIG. 4 is an exploded perspective view of the embodiment of the humidor of FIG. 3.

FIG. 5 is a perspective view of an embodiment of a two-way moisture control packet holder with embedded magnets.

FIG. 6 is an exploded perspective view of the embodiment of the two-way moisture control packet holder of FIG. 5.

FIG. 7 is a perspective view of an embodiment of a humidor in an open configuration with a two-way moisture control packet holder.

FIG. 8 is a perspective view of another embodiment of a humidor in an open configuration with a two-way moisture packet holder.

FIG. 9A is a perspective view of a stackable tray.

FIG. 9B is an exploded perspective view of the stackable tray of FIG. 9A.

FIG. 10A is a perspective view of another embodiment of a humidor in a closed configuration.

FIG. 10B is a perspective view of the humidor of FIG. 10A in an open configuration.

FIG. 11A is a perspective view of another embodiment of a humidor.

FIG. 11B is an exploded perspective view of the humidor of FIG. 11A.

FIG. 12A is a perspective view of an embodiment of a humidor divider.

FIG. 12B is an exploded perspective view of the humidor divider of FIG. 12A.

FIG. 12C is a perspective view of the humidor divider of FIG. 12A attached to a two-way moisture control packet holder.

### DETAILED DESCRIPTION OF ILLUSTRATIVE EMBODIMENT(S)

A more detailed description of the device in accordance with the present disclosure is set forth below. It should be understood that the description of the specific devices below is intended to be exemplary, and not exhaustive of all possible variations or applications. Thus, the scope of the disclosure is not intended to be limiting and should be understood to encompass variations or embodiments that would occur to persons of ordinary skill.

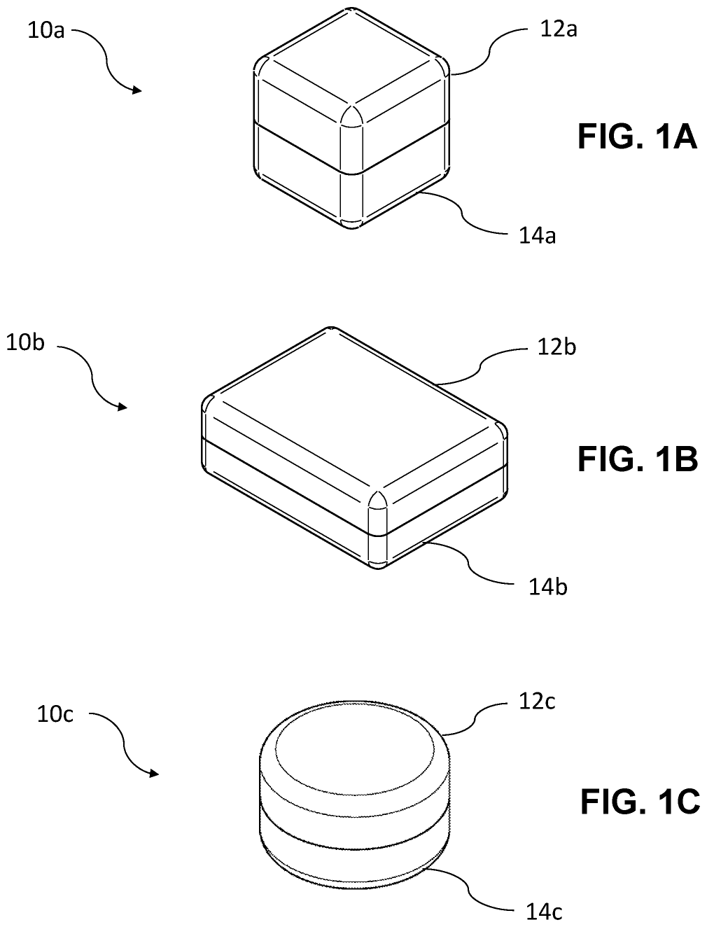

FIGS. 1A, 1B, and 1C show wood clad magnets 10a, 10b, and 10c. In some embodiments, wood clad magnets 10a, 10b, and 10c can include a magnet encased in a wooden container. In some embodiments, the magnet can be a rare earth magnet. In some embodiments, the magnet can be a permanent magnet. In some embodiments, the magnet can be an electromagnet. Other magnets can be used without departing from the scope of the disclosure.

In some embodiments, the wooden container can be a two-piece container including top piece 12a, 12b, or 12c and bottom piece 14a, 14b, or 14c. In some embodiments, wood clad magnets 10a, 10b, or 10c can be a variety of shapes including, but not limited to, rectangular prisms, cubes, cylinders, spheres, and pyramids. For instance, in some embodiments, the wood clad magnets can be a cube (as shown in FIG. 1A), a rectangular prism (as shown in FIG. 1B), or a cylinder (as shown in FIG. 1C). Other shapes can be used without departing from the scope of the disclosure. The shape of the wood clad magnet can vary depending on the intended application.

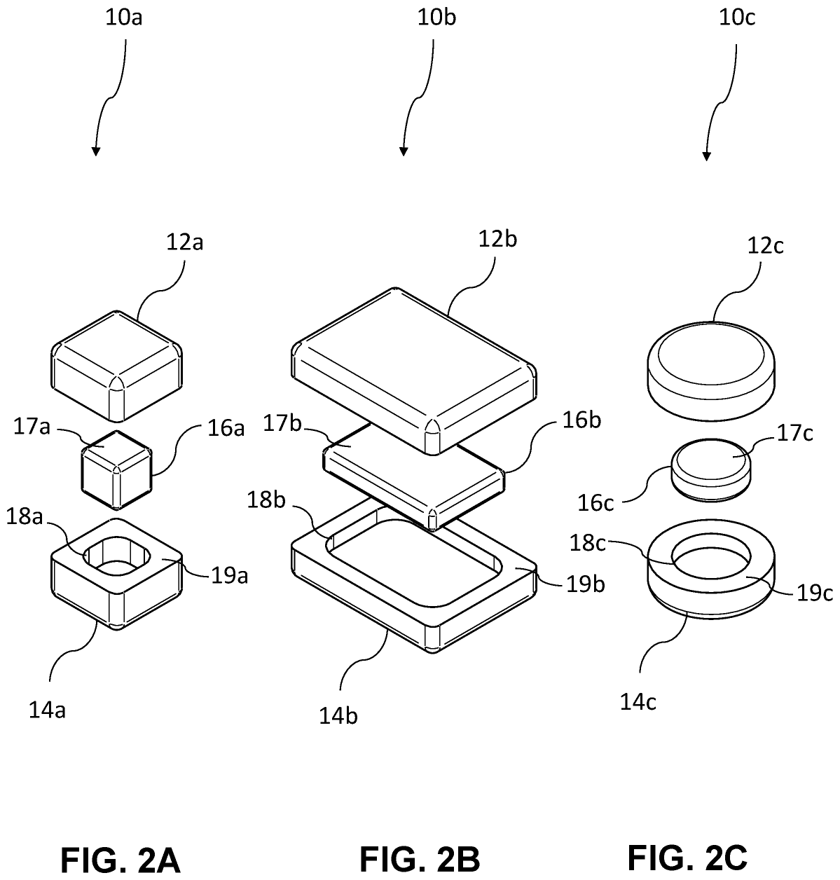

FIGS. 2A, 2B, and 2C show an exploded view of wood clad magnets 10a, 10b and 10c. In some embodiments, bottom piece 14a, 14b and/or 14c, can contain recess 18a, 18b, and/or 18c to house magnet 16a, 16b, and/or 16c. In at least some embodiments, the recess is deep enough to house the entire magnet 16a, 16b, and/or 16c so that top surface 17a, 17b, and/or 17c of magnet 16a, 16b, and/or 16c is flush with top surface 19a, 19b, and/or 19c of bottom piece 14a, 14b, and/or 14c. In at least some of these embodiments, top piece 12a, 12b, and/or 12c can have a flat bottom surface to sufficiently cover the magnet when top piece 12a, 12b, and/or 12c and bottom piece 14a, 14b, and/or 14c are attached.

In some embodiments, the recess can be deep enough to house only part of magnet 16a, 16b, and/or 16c, leaving a portion of the magnet exposed above top surface 19a, 19b, and/or 19c of bottom piece 14a, 14b, and/or 14c. In at least some of these embodiments, top piece 12a, 12b, and/or 12c can also include a recess (not shown) to house magnet 16a, 16b, and/or 16c. In some embodiments, the recess in top piece 12a, 12b, and/or 12c can be deep enough to cover the exposed portion of the magnet when top piece 12a, 12b, and/or 12c and bottom piece 14a, 14b, and/or 14c are attached.

In some embodiments, recess 18a, 18b, and/or 18c can be shaped to conform to the shape of magnet 16a, 16b, and/or 16c. For instance in some embodiments, a cube-shaped magnet 16a (as shown in FIG. 2a) can have cube shaped recess 18a. In some embodiments, prism-shaped magnet 16b (as shown in FIG. 2b) can have prism-shaped recess 18b. In some embodiments, cylinder-shaped magnet 16c can have cylinder shaped recess 18c. Other shaped magnets and correspondingly shaped recesses can be used without departing from the scope of the disclosure.

In some embodiments, top piece 12a, 12b, and/or 12c and bottom piece 14a, 14b, and/or 14c can be attached by an adhesive, for example, but not limited to glue such as polyvinyl acetate (PVA) wood glue. In some embodiments, top piece 12a, 12b, and/or 12c and bottom piece 14a, 14b, and/or 14c can be attached via mechanical means such as nails or screws. In some embodiments, top piece 12a, 12b, and/or 12c and bottom piece 14a, 14b, and/or 14c can be attached via mechanical joints. Other methods of attaching the pieces can be used without departing from the scope of the disclosure.

In some embodiments, the use of encased magnets allows for secure and discreet magnetic attachment in a variety of applications, for instance in the attachment of humidifiers, lids, and other accessories to a humidor lid or other interior surface that contains a previously attached or embedded ferromagnetic metal plate or polarity matching magnet inside of it. Wood clad magnets can be employed in other applications without departing from the scope of the disclosure.

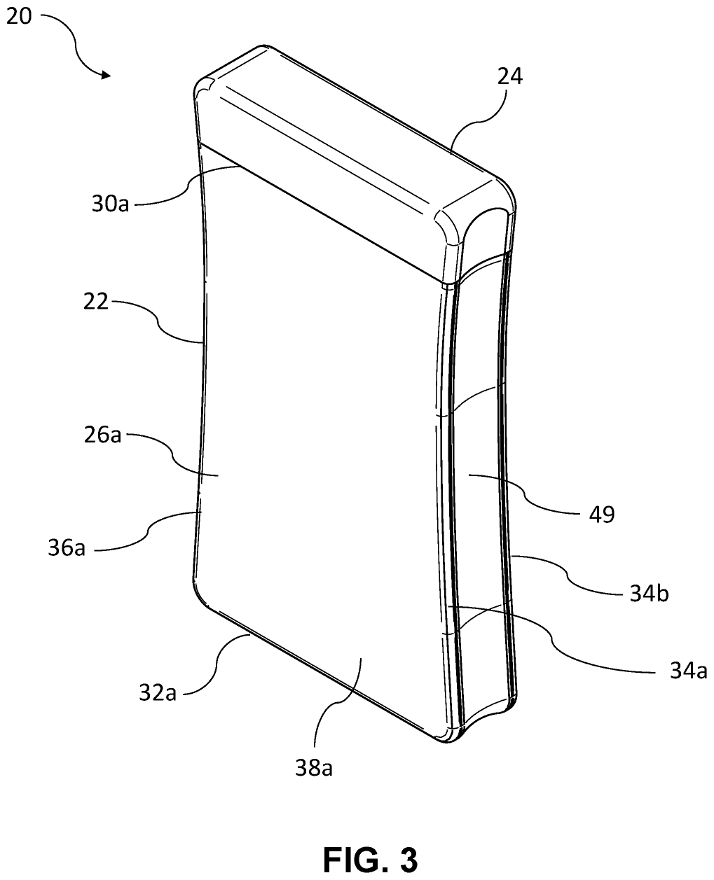

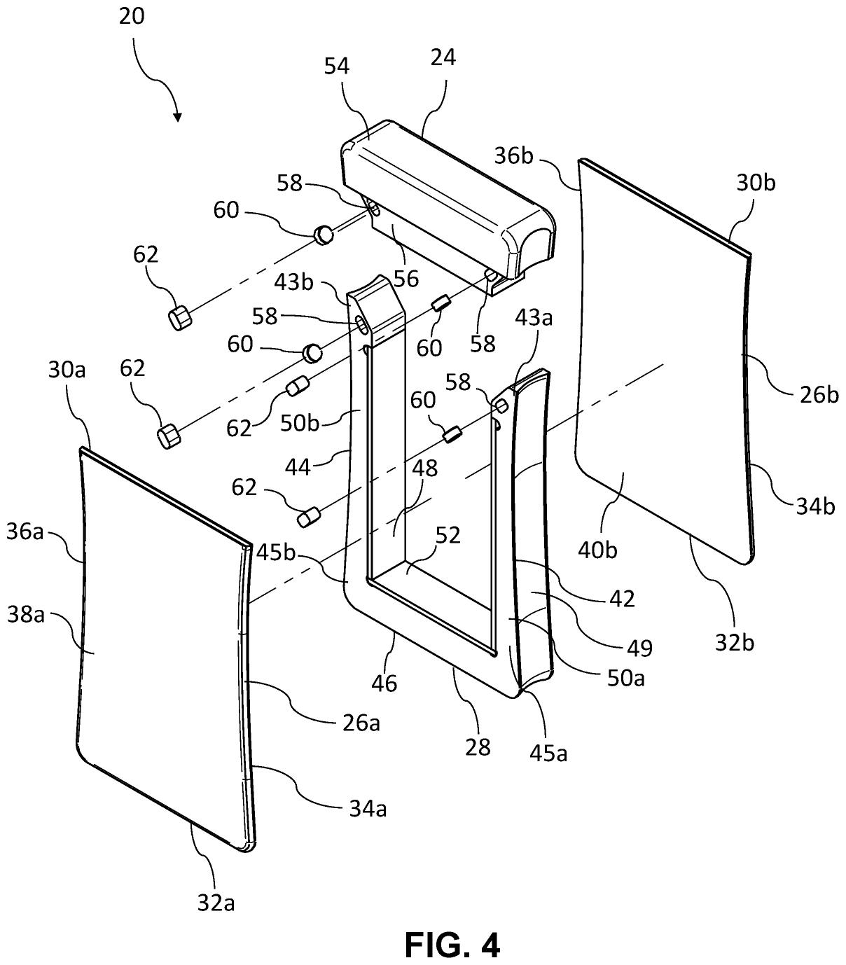

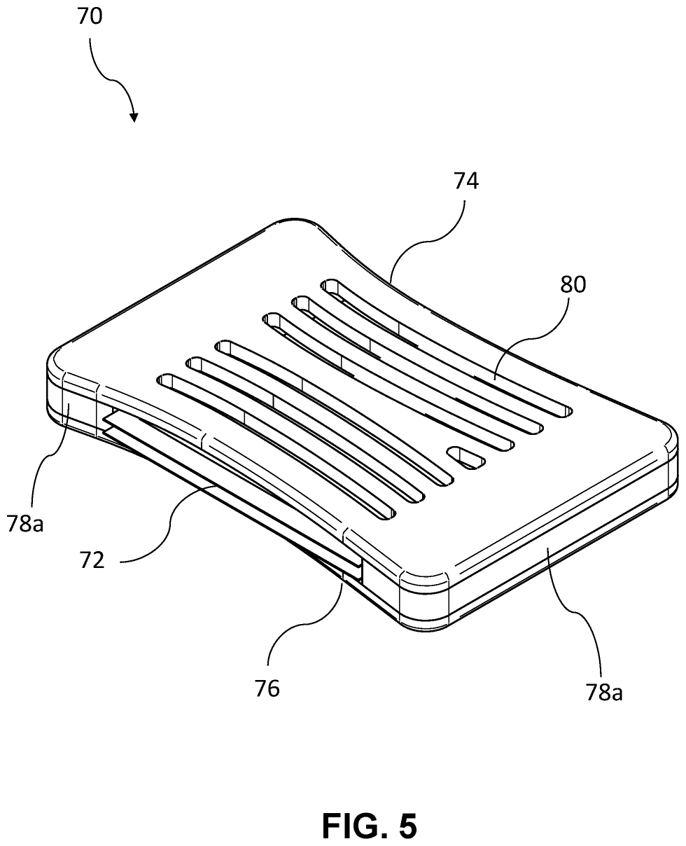

FIGS. 3 and 4 show portable humidor 20 that can include embedded magnets. In some embodiments, humidor 20 includes body 22 and lid 24. In some embodiments, body 22 includes front panel 26a and back panel 26b attached to core 28. In some embodiments, body 22 and/or lid 24 can be made of wood. In some embodiments, the inner surfaces of humidor 20 that can come into contact with the cigars can be made of, for example, but not limited to, Spanish cedar (Cedrela odorata) for its moisture retaining capability. In some embodiments, mahogany can be used for the inner surfaces of humidor 20. In some embodiments, the portable humidor is made at least in part of Spanish cedar. In some embodiments, the portable humidor is made entirely out of Spanish cedar with the exception of any magnets or ferromagnetic material. Other woods that retain moisture can be used without departing from the scope of the disclosure.

Turning to FIG. 4, in some embodiments, front panel 26a and/or back panel 26b can be generally rectangular. In some embodiments, front panel 26a includes top edge 30a, bottom edge 32a, first side edge 34a, and/or second side edge 36a. In some embodiments, back panel 26b includes top edge 30b, bottom edge 32b, first side edge 34b, and/or second side edge 36b.

In some embodiments, first side edge 34a, first side edge 34b, second side edge 36a and/or second side edge 36b can be concave. In some embodiments, front panel 26a includes an inner surface (not visible) and outer surface 38a. In some embodiments, back panel 26b includes inner surface 40b and an outer surface (not visible). In some embodiments, inner surfaces can be attached to core 28 to create body 22 of humidor 20. In some embodiments, the panels can be attached to the core by an adhesive, for example, but not limited to, wood glue. In some embodiments, the panels can be attached to the core by a two-sided adhesive waterproof membrane. In some embodiments, the panels can be attached to the core via mechanical means, such as by using screws. Other methods of attaching the panels to the core can be used without departing from the scope of the disclosure.

In some embodiments, a decorative veneer can be attached to the outer surfaces of front panel 26a and/or back panel 26b. In some embodiments, the veneer can be attached to the outer surfaces by an adhesive, for example, but not limited to, wood glue. Other methods of attaching a veneer to the panels can be used without departing from the scope of the disclosure.

In some embodiments, core 28 can generally be U-shaped and include first side wall 42, second side wall 44, and/or bottom wall 46. In some embodiments, first side wall 42 can include top end 43a, bottom end 45a, an inner surface (not visible), outer surface 49, front surface 50a, and/or a back surface (not visible). In some embodiments, second side wall 44 can include top end 43b, bottom end 45b, inner surface 48, an outer surface (not visible), front surface 50b, and/or a back surface (not visible). In some embodiments, bottom wall 46 can include inner surface 52 and a bottom surface (not visible). In some embodiments, core 28 can be a singular structure. In some embodiments, core 28 can be assembled of separate pieces including side wall 42, side wall 44 and/or bottom wall 46. In some of these embodiments, bottom end 45a and bottom end 45b of side wall 42 and side wall 44 are attached to opposite ends of bottom wall 46.

In some embodiments, the outer surfaces of first side wall 42 and/or second side wall 44 of core 28 can be concave and coved. In some embodiments, this shape allows for an ergonomic grip by a user. Additionally, in some embodiments, when the humidor 20 is placed on its side, the curvature of the coved outer surface of exposed sidewall 42 and/or exposed sidewall 44 can be used as a cigar rest.

In some embodiments, when assembled, the inner surfaces of first side wall 42, second side wall 44, bottom wall 46, front panel 26a and back panel 26b define a chamber. In some embodiments, the chamber can have dimensions sufficient to house at least one cigar. Preferably, the chamber can have dimensions to house a plurality of cigars. In some embodiments, the chamber can have dimensions sufficient to house at least two cigars. In some embodiments, the chamber can have dimensions sufficient to house at least three cigars. In some embodiments, the chamber can have dimensions sufficient to house at least four cigars. In some embodiments, the cigars are 54 ring gauge cigars. In some embodiments, the cigars are 60 ring gauge cigars. In some embodiments, the cigars are between 18 and 78 ring gauge cigars.

In some embodiments, lid 24 can be shaped to seal the opening of the chamber defined by the inner surfaces of side wall 42, side wall 44, bottom wall 46, front panel 26a and back panel 26b. In some embodiments, lid 24 can include top portion 54 and bottom portion 56. In at least some embodiments, when humidor 20 is in a closed configuration, top portion 54 can securely rest on top of the top portion 43a of side wall 42 and top portion 43b of side wall 44. In some embodiments, bottom portion 56 protrudes into the chamber. In some embodiments, top portion 43a of side wall 42 and/or top portion 43b of side wall 44 can have a beveled surface sloping towards the chamber. In some of these embodiments, bottom portion 56 of lid 24 can have a corresponding beveled side surface, allowing for a tight seal.

In some embodiments, lid 24 can be secured to body 22 via magnetic forces between at least two magnets. In some embodiments, the bottom portion 56 of lid 24, top portion 43a of side wall 42 and/or top portion 43b of side wall 44 can include cavities 58. In some embodiments, cavities 58 can contain magnets 60. In some embodiments, the cavities can contain wood clad magnets (such as those shown in FIGS. 2A, 2B, and 2C). In some embodiments, cavities 58 can be shaped to have an area that corresponds to the shape of the magnets. In some embodiments, by corresponding the shape of the cavities 58 to the magnets, the risk of creating air gaps diminishes, thus retaining the magnetic strength of the magnets and minimizing, or at least reducing wear and noise caused by magnets moving in the cavities. In some embodiments, it is necessary to place the magnets in an orientation where the magnets in core 28 attract the magnets in the lid 24. In some embodiments, the magnets are free to move in the cavities, such that orientation of the magnets is not necessary. In some embodiments, at least some cavities can be filled with a piece of ferromagnetic material.

In some embodiments, plugs 62 can be used to seal cavity 58 and/or to encase magnet 60 into lid 24 and/or core 28.

In some embodiments, lid 24 can be secured to body 22 via magnetic forces between at least one magnet and at least one ferromagnetic material. In some embodiments, the ferromagnetic material can be a metal plate, but other magnetic materials can be used without departing from the scope of this disclosure. In some embodiments, top portion 43a of side wall 42 and/or top portion 43b of side wall 44 can include cavities 58. In some embodiments, cavities 58 can contain magnets 60 or wood clad magnets as described above. In some of these embodiments, a ferromagnetic material can be embedded in bottom portion 56 of lid 24.

In some embodiments, bottom portion 56 of lid 24 can include cavities 58. In some embodiments, cavities 58 can contain magnets 60 or wood clad magnets as described above. In some of these embodiments, top portion 43a of side wall 42 and/or top portion 43b of side wall 44 can include an embedded ferromagnetic material.

In at least some embodiments, the surfaces that are intended for attachment allow for flat and direct contact throughout the surface area of the embedded magnets 60 with each other and/or with the embedded ferromagnetic material. For instance, in some embodiments, the beveled top portion 43a of side wall 42 and/or the beveled top portion 43b of side wall 44 can fully contact the beveled side portions of bottom portion 56 of lid 24.

FIG. 5 shows a two-way moisture control packet holder 70 with moisture control packet 72 that can be used in a humidor. Moisture control packets are often used in humidors to maintain humidity inside the humidor to better preserve cigars. In some embodiments, packet holder 70 can be made of wood, for example, but not limited to Spanish cedar (Cedrela odorata) for its moisture retaining characteristics. Other woods known to retain moisture can be used without departing from the scope of the disclosure.

In some embodiments, packet holder 70 can include first panel 74 and/or second panel 76. In some embodiments, spacer 78a and/or spacer 78b can be sandwiched between first panel 74 and second panel 76 to define a slot for holding moisture control packet 72. In some embodiments, moisture control packet 72 can be held in the slot by friction forces. In some embodiments, first panel 74 and/or second panel 76 can include a plurality of vents 80 cut out of the panel. In some embodiments, vents 80 allow moisture to travel through packet holder 70 to interact with moisture control packet 72. In some embodiments, first panel 74 and/or second panel 76 can include at least one vent 80 cut out of the panel.

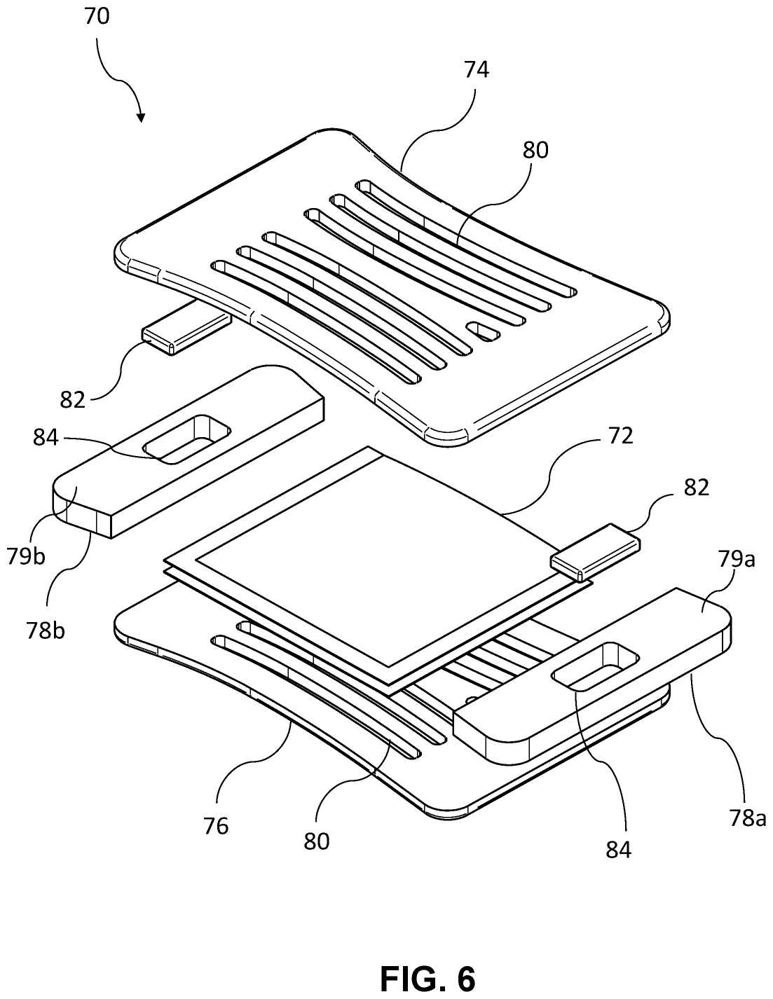

In some embodiments, packet holder 70 can be attached to a humidor via magnetic forces. In some embodiments, such as the one shown in FIG. 6, spacer 78a and/or spacer 78b can include recesses 84 to hold magnets 82. In some embodiments, recess(es) 84 can hold wood clad magnets as described above. In some embodiments, recess(es) 84 can be shaped to have an area that corresponds to the shape of the magnets. In at least some embodiments, by corresponding the shape of the recess(es) 84 to the magnet(s), the risk of creating air gaps diminishes, thus retaining the magnetic strength of the magnets and minimizing, or at least reducing wear and noise caused by magnets moving in the recess(es). In some embodiments, first panel 74 can be attached to top surface 79a and/or top surface 79b of spacer 78a and/or spacer 78b to embed at least one magnet 82 into packet holder 70.

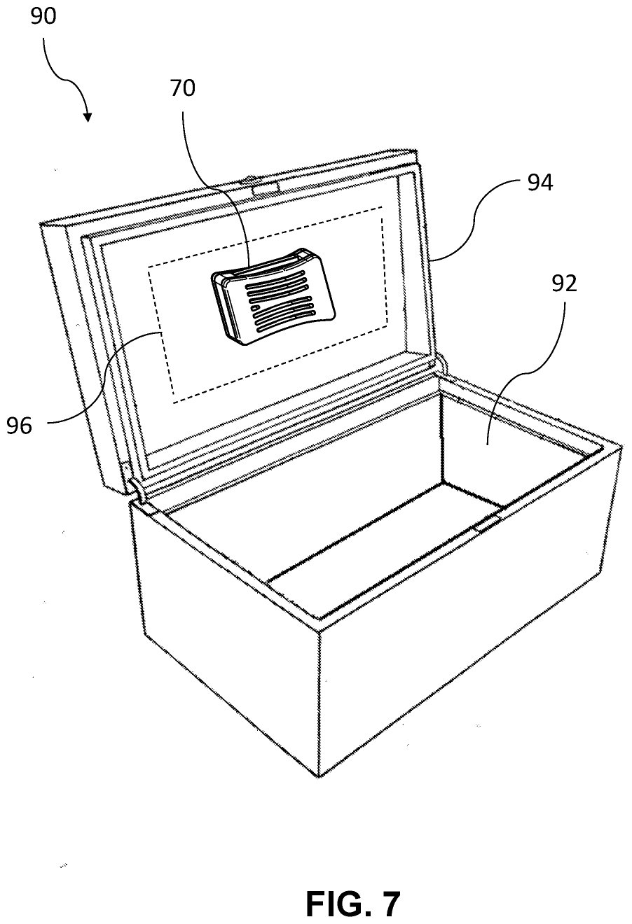

FIG. 7 shows humidor 90 in an open configuration with packet holder 70 attached. In some embodiments, humidor 90 can be a large desktop humidor. In some embodiments, humidor 90 can include container 92 and lid 94. In some embodiments, container 92 is attached to lid 94 via hinges. In some embodiments, lid 94 can contain embedded magnetic material 96, for example, a magnet or a ferromagnetic metal. In some embodiments, lid 94 can be made of (or at least of part of lid 94 can be made of) magnetic material 96, for example, a magnet or a ferromagnetic metal. In some embodiments, packet holder 70 can attach to lid 94 via magnetic forces between at least one embedded magnet 82 in packet holder 70 and embedded magnetic material 96. In some embodiments, packet holder 70 can be attached to other humidors containing magnetic material. In some embodiments, by attaching packet holder 70 via magnetic forces to lid 94, the moisture control packet and holder 70 do not take up space within the container that could otherwise be used to store cigars. Additionally, by using magnetic forces to attach the holder 70 to lid 94 instead of traditional adhesives, which can lose adhesive strength in a humid environment, there is less of a risk of holder 70 falling and damaging the contents of the container.

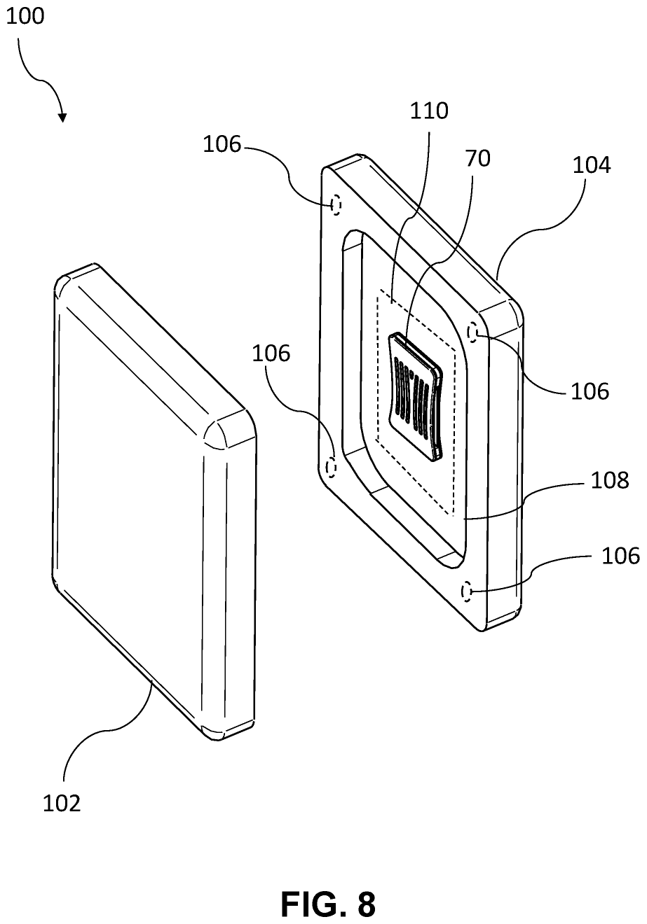

FIG. 8 shows another embodiment of humidor 100 that can employ embedded magnets. In some embodiments, humidor 100 can include body 102 and lid 104. In some embodiments, body 102 can include a recess to hold cigars. In some embodiments, body 102 and lid 104 can include at least one cavity 106 containing magnets or wood clad magnets as described above. In some embodiments where magnets are used, at least one cavity 106 can be covered with plugs to embed the magnets. In some embodiments, at least one of body 102 and lid 104 can include at least one cavity containing at least one magnet, and at least one of body 102 and lid 104 can include an embedded ferromagnetic material such as a metal plate.

In some embodiments, packet holder 70 can be attached to a magnetic material 110 embedded in lid 104. In some embodiments, lid 104 of humidor 100 can include a recess 108, providing more storage space for cigars when a packet holder 70 is attached to lid 104.

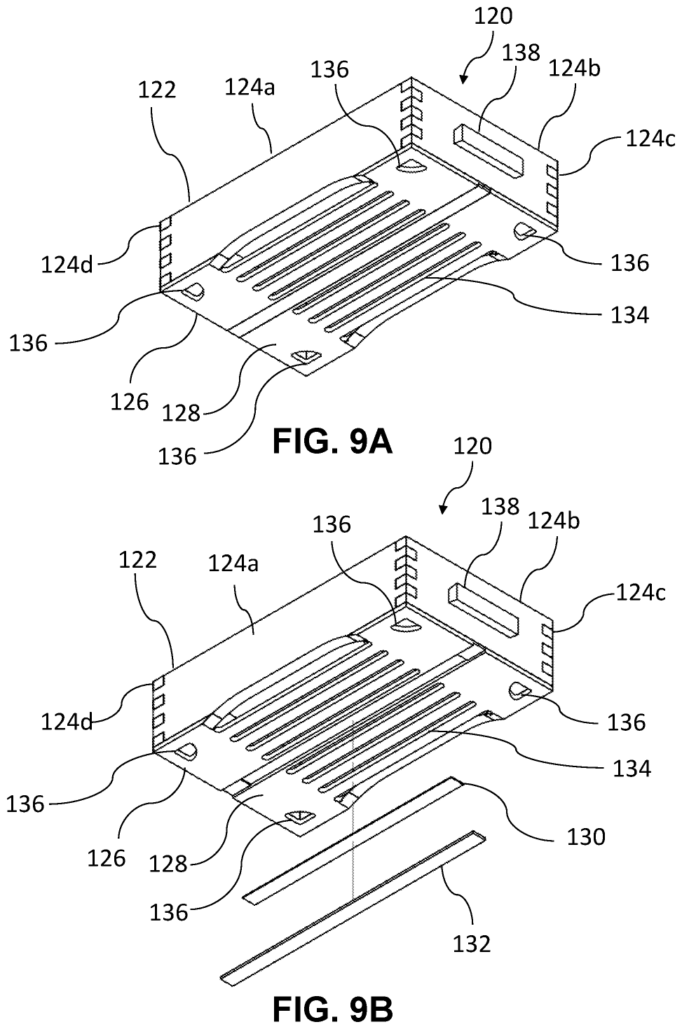

FIG. 9A and FIG. 9B, show an embodiment of stackable tray 120. In some embodiments, stackable tray 120 can fit into a desktop humidor. In some embodiments, stackable tray 120 includes container 122 and a lid (not shown). In some embodiments, stackable tray 120 includes container 122 configured to be sealed by the bottom wall 126 of another stackable tray 120.

In some embodiments, container 122 includes a cavity defined by side walls 124a, 124b, 124c, 124d, and bottom wall 126. In some embodiments, bottom wall 126 can contain embedded magnetic material 130, for example a magnet or a ferromagnetic metal. In some embodiments, magnetic material 130 can span the entire bottom wall 126. In some embodiments, magnetic material 130 can be a magnetic strip. In some embodiments, magnetic material 130 can be positioned at a central location in bottom wall 126. In some embodiments, magnetic material 130 can be covered by a cover 132 made of the same material as stackable tray 120 to embed the magnetic material 130 into the bottom wall 126. In some embodiments, the cover 132 is made of Spanish cedar. Other woods that retain moisture can be used without departing from the scope of the disclosure.

In some embodiments, packet holder 70 can attach to bottom surface 128 of bottom wall 126. In some embodiments, other magnetic packet holders can be attached to stackable tray 120. In some embodiments, by attaching packet holder 70 to bottom surface 128 of bottom wall 126, when in a stacked configuration, moisture control packet 72 and holder 70 attached to a top stackable tray 120 can provide consistent distribution of humidification throughout stored cigars in a bottom stackable tray which is being sealed by bottom wall 126 of top stackable tray 120.

Additionally, in some embodiments, bottom surface 128 of bottom wall 126 can include parallel grooves 134. In some embodiments, parallel grooves/vents 134 assist in distributing moisture through a cavity of stackable tray 120 being sealed by bottom wall 126. In some embodiments, the corners of bottom surface 128 of bottom wall 126 can include cut-outs 136. In some embodiments, cut-outs are configured to receive a raised element located on the top of at least one of side wall 124a, side wall 124b, side wall 124c and/or side wall 124d. In some embodiments, raised elements can be shaped to correspond with the cut-outs and are configured to hold stackable tray 120 in place when stacked on top of another stackable tray 120.

In some embodiments, stackable tray 120 includes handle 138 on at least one of side wall 124a, side wall 124b, side wall 124c and/or side wall 124d. In some embodiments, stackable tray 120 includes two handles 138, each located on an opposite side wall. The number of handles 138 and/or their locations can vary without departing from the scope of the disclosure. In some embodiments, handles 138 can assist a user in lifting stackable tray 120 off another stackable tray 120.

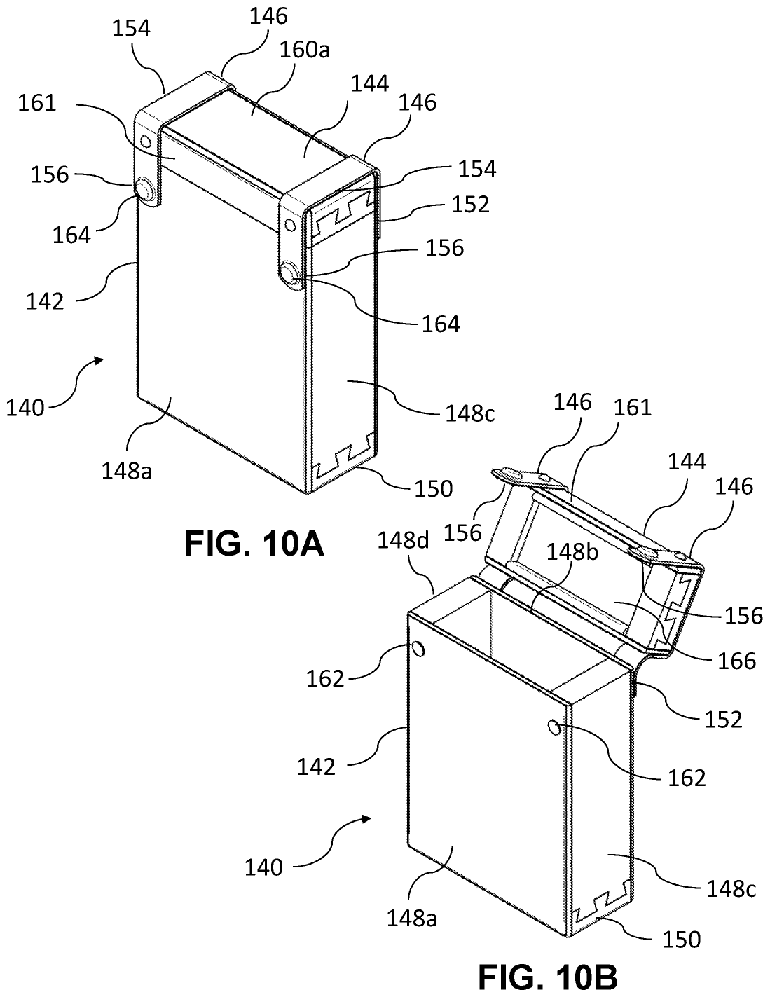

Turning to FIG. 10A and FIG. 10B, humidor 140 is shown in a closed and open configuration, respectively. In some embodiments, humidor 140 can be a portable humidor. In some embodiments, humidor 140 can include container 142 and lid 144. In some embodiments, container 142 includes a cavity defined by front wall 148a, back wall 148b, side wall 148c, side wall 148d and bottom wall 150.

In some embodiments, lid 144 is attached to container 142 via hinges 146. In some embodiments, humidor 140 includes at least two hinges 146. In some embodiments, hinges 146 are leather straps. In some embodiments, first end 152 of hinge 146 can be attached to back wall 148b and intermediate portion 154 of hinge 146 can be attached to top surface 160 and/or front surface 161 of lid 144. In some embodiments, second end 156 of hinge 146 can be configured to be attachable to front wall 148a. In some embodiments, front wall 148a includes magnetic material 162 configured to attach to magnetic material 164 on second end 156 of hinge 146. In some embodiments, magnetic material 162 can be embedded into front wall 148a. In some embodiments, front wall 148a includes magnetic material 162 associated with each individual hinge 146 of humidor 140. In some embodiments, magnetic material 162 and/or magnetic material 164 can be a magnet or a ferromagnetic metal. In some embodiments, magnetic material 162 associated with front wall 148a has an opposite polarity than magnetic material 164 associated with hinge 146, such that the attraction between magnetic material 162 and magnetic material 164 holds lid 144 sealed when humidor 140 is in a closed configuration.

In some embodiments, front wall 148a, back wall 148b, side wall 148c, side wall 148, and/or lid 144 can contain embedded magnetic material, for example, a magnet or a ferromagnetic metal. In some embodiments, packet holder 70 can attach to the inside of container 142 and/or lid 144 via the embedded magnetic material.

In some embodiments, lid 144 can include recess 166 configured to a receive packet holder (such as receive packet holder 70). In some embodiments, by attaching packet holder 70 via magnetic forces to lid 144, moisture control packet 72 and holder 70 do not take up space within container 142 that could otherwise be used to store cigars. Additionally, by using magnetic forces to attach the holder to lid 144 instead of traditional adhesives, which can lose adhesive strength in a humid environment, there is less of a risk of holder 70 falling and damaging the contents of the container. In some embodiments, other magnetic packet holders can attach to humidor 140 without departing from the scope of the disclosure.

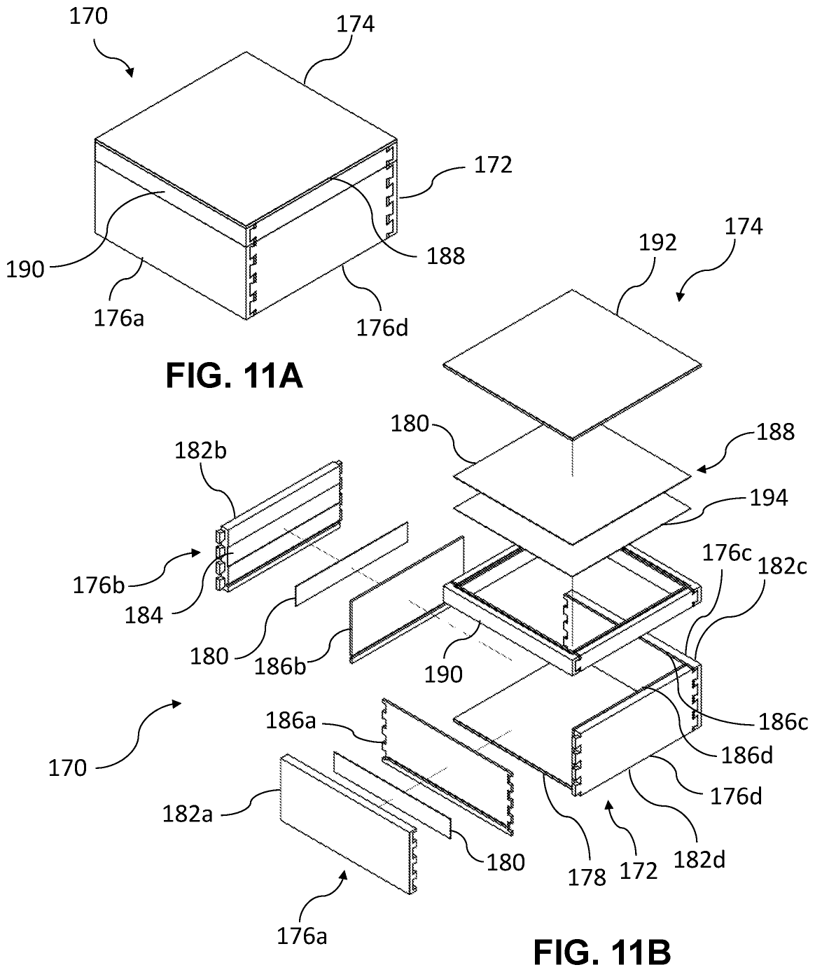

FIG. 11A and FIG. 11B, show an embodiment of humidor 170. In some embodiments, humidor 170 is a desktop humidor. In some embodiments, humidor 170 includes container 172 and lid 174. In some embodiments, container 172 includes a cavity defined by side wall 176a, side wall 176b, side wall 176c, side wall 176d, and bottom wall 178.

In some embodiments, side wall 176a, side wall 176b, side wall 176c, side wall 176d, and/or lid 174 can contain embedded magnetic material 180, for example a magnet or a ferromagnetic metal. In some embodiments, packet holder 70 can attach to side wall 176a, side wall 176b, side wall 176c, side wall 176d, and/or lid 174 via magnetic forces between magnets 82 in packet holder 70 and embedded magnetic material 180.

In some embodiments, side wall 176a, side wall 176b, side wall 176c, and/or side wall 176d include a layered construction to embed magnetic material 180 into humidor 170. In some embodiments, magnetic material 180 can span the entire side wall 176a, side wall 176b, side wall 176c and/or side wall 176d. In some embodiments, magnetic material 180 can be at least one strip of magnetic material. In some embodiments, magnetic material 180 can be a strip of magnetic material positioned in a central location and spans the length of side wall 176a, side wall 176b, side wall 176c and/or side wall 176d. In some embodiments, side wall 176a, side wall 176b, side wall 176c and side wall 176d include outer layer 182a, outer layer 182b, outer layer 182c, and outer layer 182d, respectively. In some embodiments, outer layer 182a, outer layer 182b, outer layer 182c, and/or outer layer 182d can include recess(es) 184 configured to receive magnetic material 180. In some embodiments, the recess(es) can be shaped to correspond with the shape of magnetic material 180. In some embodiments, cover layer 186a, cover layer 186b, cover layer 186c, and cover layer 186d can attach to outer layer 184a, outer layer 184b, outer layer 184c, and outer layer 184d, to embed magnetic material 180 into side wall 176a, side wall 176b, side wall 176c, and side wall 176d. In some embodiments, at least cover layer 186a, cover layer 186b, cover layer 186c, and/or cover layer 186d can be made of a moisture retaining material, for example, Spanish cedar. Other woods that retain moisture can be used without departing from the scope of the disclosure. In some embodiments, the entire side wall 176a, side wall 176b, side wall 176c, and/or side wall 176d can be made of a moisture retaining material, for example, Spanish cedar. Other woods that retain moisture can be used without departing from the scope of the disclosure.

In some embodiments, lid 174 includes top wall 188 and frame 190. In some embodiments, top wall 188 includes a layered construction to embed the magnetic material 180 into humidor 170. In some embodiments, top wall 188 includes, from top to bottom, outer layer 192, magnetic material 180, and inner layer 194. In some embodiments, a portion of lid 174 can be made of a moisture retaining material. In some embodiments, outer layer 192, inner layer 194, and/or frame 190 can be made of a moisture retaining material, for example, Spanish cedar. Other woods that retain moisture can be used without departing from the scope of the disclosure. In some embodiments, magnetic material 180 can span the entire area of top wall 188. In some embodiments, magnetic material 180 can partially cover the area of top wall 188. In some embodiments, magnetic material 180 can be at least one strip of magnetic material.

In some embodiments, top wall 188 can be attached to the top of frame 190 to from lid 174. In some embodiments, frame 190 and top wall 188 define a recess configured to receive packet holder 70 in lid 174. In some embodiments, packet holder 70 can attach to lid 174 via magnetic forces between at least one embedded magnet 82 in packet holder 70 and embedded magnetic material 180. In some embodiments, by attaching packet holder 70 via magnetic forces to lid 174, moisture control packet 72 and holder 70 do not take up space within container 172 that could otherwise be used to store cigars. Additionally, by using magnetic forces to attach holder 70 to lid 174 instead of traditional adhesives, which can lose adhesive strength in a humid environment, there is less of a risk of holder 70 falling and damaging the contents of container 172.

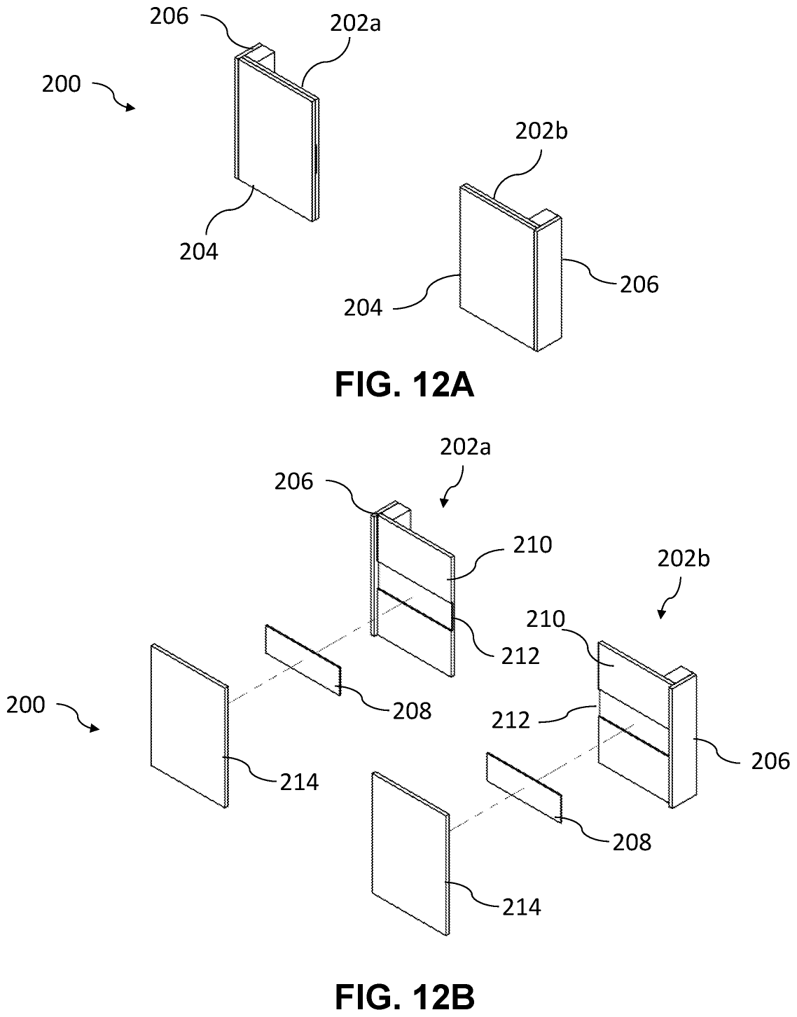

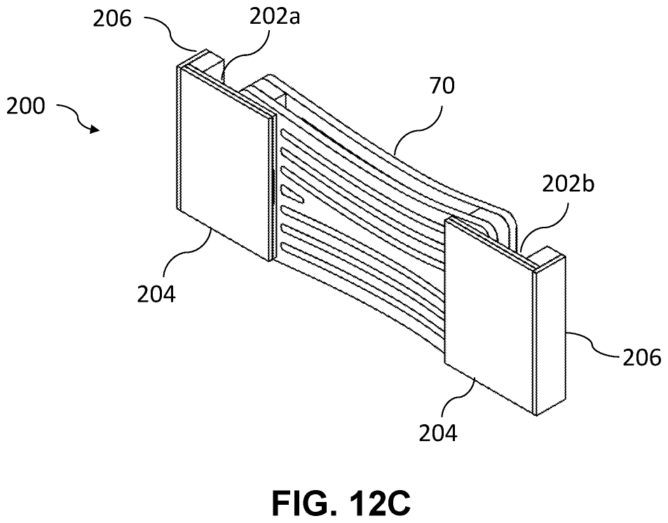

FIG. 12A, FIG. 12B, and FIG. 12C show an embodiment of humidor divider 200. In some embodiments, humidor divider 200 can be used create separate compartments within a container of a humidor. In some embodiments, divider 200 can be used with at least some of the the humidors described herein. In some embodiments, divider 200 can be used with other humidors without departing from the scope of the disclosure.

In some embodiments, humidor divider 200 includes two holders 202a and 202b. In some embodiments, holders 202a and 202b include the same components and arrangement of components, such that they are mirror images of one another. In some embodiments, holders 202a and 202b are generally “L” shaped. In some embodiments, holders 202a and 202b each include dividing wall 204 and humidor abutting wall 206 arranged perpendicularly to dividing wall 204. In some embodiments, dividing wall 204 can contain embedded magnetic material 208, for example a magnet or a ferromagnetic metal. In some embodiments, dividing wall 204 includes a layered construction to embed magnetic material 208. In some embodiments, magnetic material 208 can span the entire area of dividing wall 204. In some embodiments, magnetic material 208 can be at least one strip of magnetic material. In some embodiments, magnetic material 208 can be a strip of magnetic material positioned in a central location and spans the length of dividing wall 204. In some embodiments, dividing wall 204 includes inner layer 210. In some embodiments, inner layer 210 can include one or more recesses 212 configured to receive magnetic material 208. In some embodiments, recess(es) 212 can be shaped to correspond with the shape of magnetic material 208. In some embodiments, cover layer 214 can attach to inner layer 210, to embed magnetic material 208 into dividing wall 204. In some embodiments, at least a portion of holder 202a and/or holder 202b can be made of a moisture retaining material, for example, Spanish cedar. Other woods that retain moisture can be used without departing from the scope of the disclosure. In some embodiments, dividing walls 204, humidor abutting walls 206, and/or portions thereof can be made of a moisture retaining material, for example, Spanish cedar. Other woods that retain moisture can be used without departing from the scope of the disclosure.

FIG. 12C shows holder 202a and holder 202b attached to packet holder 70. In some embodiments, packet holder 70 can attach to holder 202a and/or holder 202b via magnetic forces between embedded magnets 82 in packet holder 70 and embedded magnetic material 208 in holders 202a and holder 202b. In some embodiments, packet holder 70 acts as a separating wall. In some embodiments, by attaching packet holder 70 to holder 202a and holder 202b and using holder 70 as a separating wall, packet holder 70 not only divides a humidor into separate compartments, but also provides humidification inside a humidor.

In some embodiments, by attaching packet holder 70 via magnetic forces to holder 202a and/or holder 202b the size of divider 200 is adjustable, making the divider 200 suitable for humidors of varying sizes. In some embodiments, to use divider 200, packet 70 can attach to holder 202a and/or holder 202b to correspond to the length or width of the container of a humidor. In some embodiments, holder 202a and/or holder 202b are attached to packet holder 70 in positions such that humidor abutting walls 206 abut the inner walls of a humidor and is held in place by friction forces between humidor abutting wall(s) 206 and the inner walls of the humidor. In some embodiments, humidor abutting wall 206 can include an embedded magnetic material configured to attach via magnetic forces with a magnetic material embedded in a humidor wall, thus holding holder 202a and/or holder 202b in place.

In some embodiments, divider 200 can be used to create separate compartments to store contents in a humidor, for example, different types of cigars. In some embodiments, multiple dividers 200 can be placed in a humidor to create multiple compartments. The number of dividers 200 used in a humidor can vary without departing from the scope of the disclosure. While particular elements, embodiments and applications of the present invention have been shown and described, it will be understood, that the invention is not limited thereto since modifications can be made by those skilled in the art without departing from the scope of the present disclosure, particularly in light of the foregoing teachings.

It will be understood that the embodiments and examples described above are illustrative of some of the applications of the principles of the present subject matter. Numerous modifications can be made by those skilled in the art without departing from the spirit and scope of the claimed subject matter, including those combinations of features that are individually disclosed or claimed herein. For these reasons, the scope hereof is not limited to the above description but is as set forth in the following claims, and it is understood that claims can be directed to the features hereof, including as combinations of features that are individually disclosed or claimed herein.

What is claimed:

1. A portable humidor comprising:
a body made at least in part of a wood with at least one embedded magnet; and
a lid made at least in part of wood.

2. The portable humidor of claim 1 wherein said lid comprises an at least one embedded magnet.

3. The portable humidor of claim 1 wherein said lid comprises an at least one embedded ferromagnetic material.

4. The portable humidor of claim 2 wherein said body comprises
a front panel;
a back panel; and
a core.

5. The portable humidor of claim 2 wherein at least one inner surface of said portable humidor is made of Spanish cedar.

6. The portable humidor of claim 4 wherein an at least one edge of said front panel is concave in shape.

7. The portable humidor of claim 4 wherein an a first side wall of said core is concave in shape.

8. The portable humidor of claim 4 wherein said portable humidor has a chamber defined by said front panel, said back panel, and said core, wherein said chamber is configured to hold three 60 ring gauge cigars.

9. The portable humidor of claim 2 wherein said lid has a beveled side surface.

10. The portable humidor of claim 4 wherein said core has an at least one cavity configured to receive said at least one embedded magnet.

11. The portable humidor of claim 2 wherein said lid has an at least one cavity configured to receive said at least one embedded magnet.

12. The portable humidor of claim 3 wherein said at least one embedded ferromagnetic material is a metal plate.

13. A wooden packet holder made at least partially of wood comprising:
a first panel;
a second panel; and
an at least one spacer.

14. The wooden packet holder of claim 13 wherein said first panel comprises a plurality of vents.

15. The wooden packet holder of claim 13 wherein said wooden packet holder is made at least in part of Spanish cedar.

16. The wooden packet holder of claim 13 wherein said spacer comprises an at least one recess configured to hold a magnet.

17. A humidor system wherein said humidor system comprises:
a humidor comprising
a body made at least in part of a wood; and
a lid made at least in part of wood.

18. The humidor system of claim 17 further comprising:
a wooden packet holder with an at least one embedded magnet,
wherein said wooden packet holder has at least one of a second embedded magnet or a ferromagnetic material such that said wooden packet holder can attached to said lid via a magnetic force.

19. The humidor system of claim 17 further comprising:
a stackable tray with an at least one embedded magnet; and
a wooden packet holder, wherein said wooden packet holder has at least one of a second embedded magnet or a ferromagnetic material such that said wooden packet holder can attached to said stackable tray via a magnetic force.

20. The humidor system of claim 17 further comprising a humidor divider.
